(19) United States
(12) Patent Application Publication
(10) Pub. No.: US 2024/0299964 A1
(43) Pub. Date: Sep. 12, 2024

(54) Full-plastic vacuum pump head and vessel with the pump head

(71) Applicant: NINGBO LAO PLASTIC TECHNOLOGY CO., LTD., ZHEJIANG (CN)

(72) Inventor: Chengyong WANG, ZHEJIANG (CN)

(21) Appl. No.: 18/513,892

(22) Filed: Nov. 20, 2023

(30) Foreign Application Priority Data
Mar. 10, 2023 (CN) 202320447330.X

(51) Int. Cl. B05B 11/10

(52) U.S. Cl. CPC B05B 11/10

(57) ABSTRACT

The present invention discloses a full-plastic vacuum pump head, relates to the technical field of pump heads, wherein the pump head comprises a button, an upper one-way valve, a flexible rubber pump body, a lower one-way valve and a cap, the button is movably installed in the lid, the button and the cap engage with each other by sliding, a nozzle communicating with the upper one-way valve is connected with the button, the nozzle, the upper one-way valve, the flexible rubber pump body and the lower one-way valve are communicated via a liquid passage, the flexible rubber pump body is made of flexible rubber, a flexible cushioning cavity is provided in the flexible rubber pump body, when the button is subjected to pressure, liquid in the flexible cushioning cavity is guided out from the upper one-way valve, when the button is released, the liquid is guided into the flexible cushioning cavity via the lower one-way valve. A vessel equipped with the full-plastic vacuum pump head, comprising a cap, the full-plastic vacuum pump head and a vessel body. In the present invention, no spring is employed, the entire pump head is made of plastics, wherein the flexible rubber pump head is made of flexible rubber, assembly difficulty of the entire product is reduced and the recovery of the entire product is improved.

### TECHNICAL FIELD

The present invention relates to the technical field of pump heads, and specifically a full-plastic vacuum pump head and vessel equipped with the pump head.

### BACKGROUND TECHNOLOGY

With the improvement of living standards, higher and higher requirements are posed on preservation of cosmetics. For example, a patent filing number 202020224529.2 discloses a vacuum pump head and vessel, comprising specifically: a pump core assembly and a rotating lid, wherein the pump core assembly is provided in the rotating lid, wherein the pump core assembly comprises an outer cylinder and an inner core, the outer cylinder is connected with the rotating lid, an upper end of the inner core is exposed outside the rotating lid, a pressure spring is sleeved over the inner core, an end of the pressure spring is abutted against a top portion of the inner core and another end of the pressure spring is rested in the rotating lid; a snap-on cap is provided on the top portion of the inner core, and an ejection nozzle communicating with a chamber of the inner core is provided on the snap-on cap. The foregoing structures are structures of common pump heads currently available, and for existing airless pump head, there are defects of difficult assembly, involving a large number of parts, difficult disassembly, difficult recycling and liability of the springs to deteriorate, finally recycling of the entire product is affected.

### SUMMARY OF THE INVENTION

A purpose of the present invention is to provide a full-plastic vacuum pump head and vessel equipped with the vacuum head to address the problem mentioned in the background.

To realize the foregoing purpose, the present invention provides the following technical solution: a full-plastic vacuum pump head, comprising a cap, a button, an upper one-way valve, a flexible rubber pump body, a lower one-way valve and a lid, wherein the button is movable sleeved in the lid, the button engages with the lid by sliding, a nozzle communicating with the upper one-way valve is provided on the button, the nozzle, the one-way valve, the flexible rubber pump body and the lower one-way valve are communicated in sequence through a liquid passage, the flexible rubber pump body is made of a flexible rubber material, a flexible cushioning cavity is provided in the flexible rubber pump body, and when the lid is pressed on, a liquid in the flexible cushioning cavity is guided out through the upper one-way valve, and when the lid is released, the liquid is guided into the flexible cushioning cavity through the lower one-way valve.

Preferably, the flexible cushioning cavity comprises an upper cylindrical cavity and a lower bowl-shaped cavity, the upper cylindrical cavity is communicated with the upper one-way valve, a diameter of the cylindrical cavity is smaller than or equals a diameter of an upper opening of the bowl-shaped cavity, the diameter of the upper opening of the bowl-shaped cavity is smaller than a diameter of an intermediate portion of the bowl-shaped cavity and an inner cavity wall of the bowl-shaped cavity is curved inwardly. The flexible cushioning cavity resembles structures of a bowling, and when the flexible cushioning cavity is subjected to compression, the bowl-shaped cavity will extend outwards due to pressure, at this time, the liquid in the bowl-shaped cavity will be dispensed through the cylindrical cavity, the upper one-way valve and the nozzle, the diameter of the cylindrical cavity is small so that the liquid in the bowl-shaped cavity can be dispensed out; during compression, the bowl-shaped cavity extends outwards horizontally, an upper surface and a lower surface of the bowl-shaped cavity are drawn close to each other or are even fitted together, and the cylindrical cavity may be moved down into the bowl-shaped cavity during compression. With the present technical solution, not only smooth compression of the button is realized, during compression obstruction between the cylindrical cavity and the bowl-shaped cavity can be avoided and the liquid in the bowl-shaped cavity can be dispensed as much as possible. Preferably, a frustum cavity communicating with the cylindrical cavity is provided at an upper portion of the bowl-shaped cavity, diameters of the frustum cavity are increased going down, a ring-shaped groove with an inwardly curved surface is provided at a lower portion of the flexible rubber pump body relative to the cylindrical cavity, wherein the frustum cavity is a frustum structure which is smaller at an upper portion while bigger at a lower portion. By configuration of the ring-shaped groove, when pressing the flexible rubber pump body, the ring-shaped groove will fold inwards, so that the cylindrical cavity will slide downwards smoothly, and by configuring the cylindrical cavity to be a frustum an upper portion of the cylindrical cavity can be sleeved in a lower portion of the cylindrical cavity, a compression route of the flexible rubber pump body is increased and liquid residue in the flexible cushioning cavity is reduced.

Preferably, the button comprises an outer sleeve being engaged with the lid via sliding and an inner tube communicating with the nozzle, wherein the upper one-way valve comprises a valve seat and an upper valve disc, an upper sleeve airlessly joined over the inner tube is provided at an upper end of the valve seat, a lower end portion of the valve seat is airlessly fitted at an upper end portion of the flexible rubber pump body and the upper valve disc is provided inside the valve seat.

Preferably, a fitting sleeve airlessly and tightly connected to a lower portion of the valve seat is provided at an upper end portion of the flexible rubber pump body, a ring-shaped outer slot extending radially and a ring-shaped lower slot extending axially are provided at a bottom portion of the fitting sleeve; a ring-shaped outer edge extending radially is provided at a lower portion of the valve seat, the ring-shaped outer edge engages airlessly with the ring-shaped outer slot, and a ring-shaped lower edge extending axially is provided at a lower end of the valve seat, the ring-shaped lower edge engages airlessly with the ring-shaped lower slot, and the liquid passage of the valve seat and the flexible rubber pump body is located inside a circular area enclosed by the ring-shaped lower edge. First of all, by engagement between the ring-shaped outer edge and the ring-shaped outer slot, and engagement between the ring-shaped lower edge and the ring-shaped lower slot, sealing effects of the liquid passage can be improved, and leakage of the liquid during flexible deformation of the flexible rubber pump body can be prevented; secondly, by engagement of the ring-shaped outer edge and the ring-shaped outer slot axial sliding of the valve seat relative to the flexible rubber pump body can be prevented, by engagement of the ring-shaped lower edge and the ring-shaped lower slot radial sliding of the valve seat relative to the flexible rubber pump body can be prevented and connection firmness between the valve seat and the flexible rubber pump body is improved.

Preferably, a closure that is coupled over the flexible rubber pump body is provided at an upper portion of the lid, a ring-shaped movement cavity engaging with the button adaptively by sliding is provided in between the closure and the flexible rubber pump body, a ring-shaped neck extending radially outwards is provided at the lower end portion of the flexible rubber pump body, the ring-shaped neck is airlessly provided at a bottom portion of the ring-shaped movement cavity, a ring-shaped slab is provided on an upper end portion of the ring-shaped neck, the ring-shaped slab is installed at a lower portion of the ring-shaped movement cavity, and the ring-shaped slab is configured to fix the ring-shaped neck at the bottom portion of the ring-shaped movement cavity. Preferably, a housing cavity for installing the lower one-way valve is provided at an intermediate portion of the lid, a liquid inlet is provided at a lower end of the housing cavity, the lower one-way valve comprises a lower valve disc connected with the housing cavity movably, and a diameter of the lower valve disc is bigger than a diameter of the liquid inlet. When the flexible rubber pump body is pressed on, pressure in the flexible cushioning cavity is increased and as a result, the lower valve disc will block the liquid inlet when being compressed, and at this time, the bigger the pressure in the flexible cushioning cavity is, the stronger the sealing of the lower one-way valve is.

A vessel equipped with the full-plastic vacuum pump head, comprises a cap, a full-plastic vacuum pump head and a vessel body, wherein the cap is closed over the full-plastic vacuum pump head, and a lower one-way valve of the full-plastic vacuum pump head is communicated with a liquid storage cavity provided in the vessel body and a piston is provided in the liquid storage cavity.

Compared with the prior art, the beneficial effects of the present invention are:

In the present invention, no spring device is employed, the entire pump head are made of plastic structures, wherein the flexible rubber pump body is made of flexible rubbers, in this way, assembly difficulty of the product is reduced and a recycling rate of the product is improved.

### BRIEF INTRODUCTION OF DRAWINGS

FIG. 1 is a cross-section diagram of an embodiment of the present invention;

FIG. 2 is an enlarged diagram showing a part marked A in FIG. 1;

FIG. 3 is a diagram showing a state of the pump head resumed to the original position to draw the liquid; and

FIG. 4 is a diagram showing a state of the pump head being compressed to dispense the liquid.

In the drawings: 1 cap; 2 button; 3 upper one-way valve; 31 valve seat; 32 upper valve disc; 4 vessel body; 5 flexible rubber pump body; 6 lower one-way valve; 7 lid; 71 upper sleeve portion; 8 nozzle; 9 liquid passage; 10 flexible cushioning cavity; 101 cylindrical cavity; 102 bowl-shaped cavity; 11 frustum cavity; 12 ring-shaped groove; 13 outer sleeve; 14 inner tube; 15 ring-shaped outer edge; 16 ring-shaped lower edge; 17 ring-shaped movement cavity; 18 ring-shaped neck; 19 ring-shaped slab; 20 lower valve disc; 21 liquid storage cavity and 22 piston.

### Embodiments

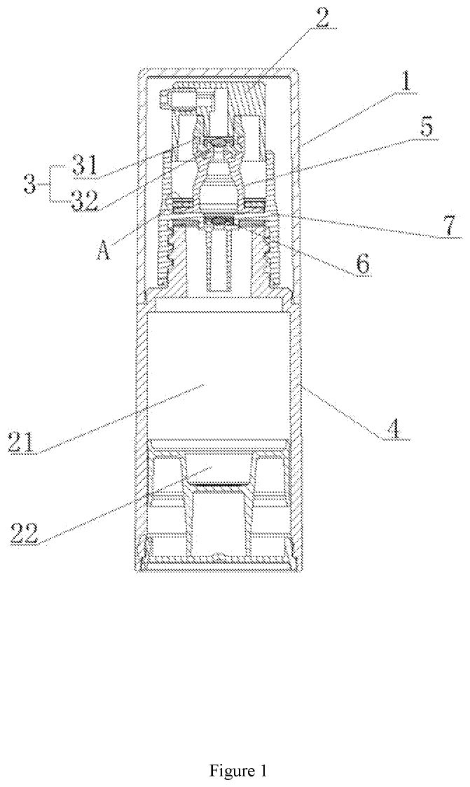

Hereinafter a clear and complete description will be given to the technical solutions in embodiments of the present invention with reference to drawings of the embodiments of the present invention, apparently, the embodiments given here are only some of the embodiments of the present invention rather than all. Based on the embodiments of the present invention, all other embodiments obtained by those of ordinary skill in the art without making creative effort fall into the protection scope of the present invention. Hereinafter a further description will be given to the present invention based on FIGS. 1-4 and the embodiments.

Embodiment: as shown in FIG. 1, a vessel equipped with a full-plastic vacuum pump head, comprises a cap 1, a full-plastic vacuum pump head, and a vessel body 4, wherein the cap 1 is closed over the full-plastic vacuum pump head, a lower one-way valve 6 of the full-plastic vacuum pump head is communicated with a liquid storage cavity 21 provided in the vessel body 4 and a piston 22 is provided in the liquid storage cavity 21. The full-plastic vacuum pump head, comprises a button 2, an upper one-way valve 3, a flexible rubber pump body 5, a lower one-way valve 6 and a lid 7, wherein the cap 2 is movably sleeved inside the lid 7, the button 2 and the lid 7 engage with each other adaptively by sliding, a nozzle 8 connected with the upper one-way valve 3 is provided in the button 2, the nozzle 8, the upper one-way valve 3, the flexible rubber pump body 5 and the lower one-way valve 6 are communicated in sequence via a liquid passage 9, the flexible rubber pump body 5 is made of a flexible rubber material, a flexible cushioning cavity 10 is provided in the flexible rubber pump body 5, when the button 2 is pressed, a liquid in the flexible cushioning cavity 10 is guided out through the upper one-way valve 3, and when the button 2 is released, the liquid is guided to flow into the flexible cushioning cavity 10 through the lower one-way valve 6.

The flexible cushioning cavity 10 comprises a cylindrical cavity 101 at an upper position and a bowl-shaped cavity 102 at a lower position, the cylindrical cavity 101 is communicated with the bowl-shaped cavity 102, a diameter of the cylindrical cavity 101 is smaller than or equals a diameter of an upper opening of the bowl-shaped cavity 102, the diameter of the upper opening of the bowl-shaped cavity 102 is smaller than a diameter of an intermediate portion of the bowl-shaped cavity 102, and an inner cavity wall of the bowl-shaped cavity 102 comprises an inwardly curved structure. The entire flexible cushioning cavity 10 resembles a bowling structurally, when the flexible cushioning cavity 10 is subjected to pressure, the bowl-shaped cavity 102 will extend outwards due to the pressure, at this time, the liquid in the bowl-shaped cavity 102 will be sprayed out through the cylindrical cavity 101, the upper one-way valve 3 and the nozzle 8, as the diameter of the cylindrical cavity 101 is quite small the liquid in the bowl-shaped cavity 102 can flow out; during compression, the bowl-shaped cavity 102 extends outwards horizontally, an upper opening and a lower opening of the bowl-shaped cavity 102 are pressed close to each other or are even fitted against each other, and during compression the cylindrical cavity 101 is driven to move downwards until inside the bowl-shaped cavity 102. With the foregoing technical solution, smooth compression of the button 2 can be realized, obstruction between the cylindrical cavity 101 and the bowl-shaped cavity 102 due to mutual abutment of the cylindrical cavity 101 and the bowl-shaped cavity 102 during compression is avoided and it is convenient to discharge the liquid in the bowl-shaped cavity 102. A frustum cavity 11 communicating with the cylindrical cavity 101 is provided at an upper portion of the bowl-shaped cavity 102, diameters of the frustum cavity 11 increase sequentially going down, a ring-shaped groove 12 with an inwardly curved surface is provided in the flexible rubber pump body 5 relative to a lower portion of the cylindrical cavity 101, and the frustum cavity 101 comprises a frustum structure which is smaller at an upper portion while bigger at a lower portion. By configuration of the ring-shaped groove 12, during pressing the flexible rubber pump body 5, the ring-shaped groove 12 curves inwardly, so smooth downward movement of the cylindrical cavity 101 is facilitated, by configuring the cylindrical cavity to be a frustum structure, the upper portion of the cylindrical cavity 101 can be sleeved inside the lower portion of the cylindrical cavity 101, a pressing route of the flexible rubber pump body 5 is increased, liquid residue in the flexible cushioning cavity 10 is reduced, and a shape of the flexible rubber pump body is designed as per mechanical principles so that compression and rebounding of the pump body is even, and good resilience can be always maintained.

The button 2 comprises an outer sleeve 13 engaging with the lid 7 by sliding and an inner tube 14 communicating with the nozzle 8, the upper one-way valve 3 comprises a valve seat 31 and an upper valve disc 32, an upper sleeve portion sleeved airlessly over the inner tube 14 is provided at an upper end portion of the valve seat 31, a lower end portion of the valve seat 31 is installed tightly in an upper end portion of the flexible rubber pump body 5 and the upper valve disc 32 is provided in the valve seat 31.

A fitting sleeve connected with a lower portion of the valve seat 31 airlessly is provided at an upper end portion of the flexible rubber pump body 5, a ring-shaped outer slot extending radially and a ring-shaped lower slot extending axially are provided at a bottom portion of the fitting sleeve; a ring-shaped outer edge 15 extending radially is provided at a lower portion of the valve seat 31, and the ring-shaped outer edge 15 and the ring-shaped outer slot engage airlessly, a ring-shaped lower edge 16 extending axially is provided at the lower end portion of the valve seat 31, and the ring-shaped lower edge 16 engages airlessly with the ring-shaped lower slot, and the liquid passage 9 of the valve seat 31 and the flexible rubber pump body 5 is provided in an area enclosed by the ring-shaped lower edge 16. First of all, by engagement and cooperation between the ring-shaped outer edge 15 and the ring-shaped outer slot, and engagement and cooperation between the ring-shaped lower edge 15 and the ring-shaped lower slot, sealing effects of the liquid passage 9 are improved, and leakage of the liquid during elastic deformation of the flexible rubber pump body 5 can be prevented; secondly, by adaptive engagement between the ring-shaped outer edge 15 and the ring-shaped outer slot axial sliding of the valve seat 31 relative to the flexible rubber pump body 5 can be prevented, by adaptive engagement of the ring-shaped lower edge 16 and the ring-shaped lower slot radial sliding of the valve seat 31 relative to the flexible rubber pump body 5 can be prevented and connection firmness between the valve seat 31 and the flexible rubber pump body 5 can be improved.

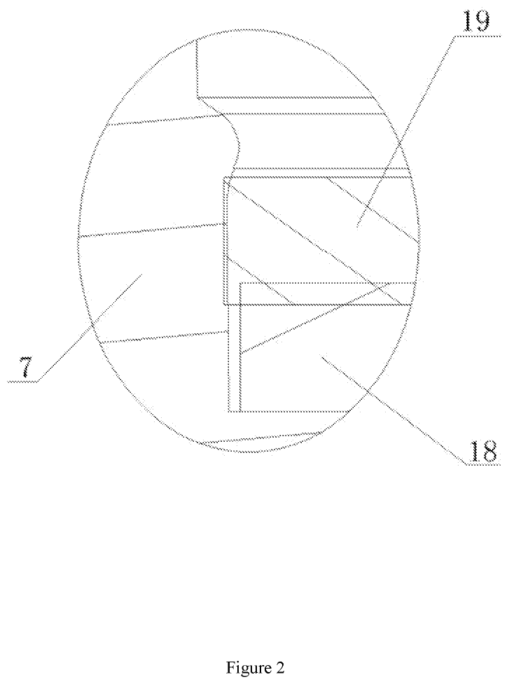

A closure 71 coupled over the flexible rubber pump body 5 is provided at an upper portion of the lid 7, a ring-shaped movement cavity 17 engaging adaptively with the button 2 by sliding is provided in between the closure 71 and the flexible rubber pump body 5, a ring-shaped neck 18 extending radially outwards is provided at a lower portion of the flexible rubber pump body 5, the ring-shaped neck 18 is airlessly provided at a bottom portion of the ring-shaped movement cavity, a ring-shaped slab 19 is provided on an upper end portion of the ring-shaped neck 18, as shown in FIG. 2, the ring-shaped slab 19 is fitted in a lower portion of the ring-shaped movement cavity 17, the ring-shaped slab 19 is configured to fix the ring-shaped neck 18 at the bottom portion of the ring-shaped movement cavity 17, a housing cavity for installing the lower one-way valve 6 is provided at an intermediate portion of the lid 7, a liquid inlet is provided at a lower end of the housing cavity, the lower one-way valve 6 comprises a lower valve disc 20 movably connected with the housing cavity, and a diameter of the lower valve disc 20 is bigger than a diameter of the liquid inlet. When the flexible rubber pump body 5 is pressed on, pressure in the flexible cushioning cavity 10 is increased, the lower valve disc 20 blocks the liquid inlet due to pressure, and at this time, the bigger the pressure in the flexible cushioning cavity 10 is, the better the sealing of the lower one-way valve 6 is.

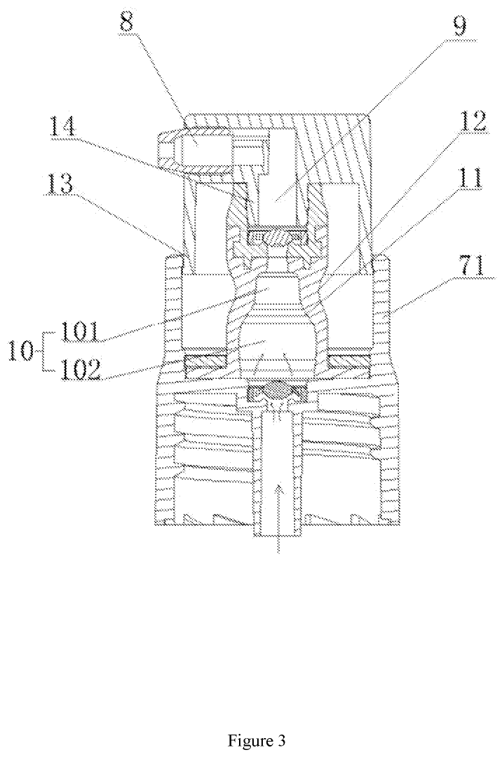

There is a defect with existing spring-free pump cores, that is, by direct connection between the button 2 and the flexible rubber pump body 5, during use, loosening of any of them is liable to occur. For the present product provided in the present invention, the flexible rubber pump body 5 and the valve seat 31 are made by double shot molding, wherein vacuum is generated in the flexible rubber pump body 5 by pressing the flexible rubber, the valve 31 is made of PP plastic, and by configuration of the ring-shaped lower edge 16 and the ring-shaped outer edge 15 on the valve seat 31 the valve seat 31 can have the button 2 fixed properly just as common pump cores do. Working principles: as shown in FIG. 3, when the button 2 is released back to an initial status under action of elastic returning force of the flexible rubber pump body 5, pressure in the flexible cushioning cavity 10 is reduced and the liquid in the liquid storage cavity 21 flows from the lower one-way valve 6 into the flexible cushioning cavity 10.

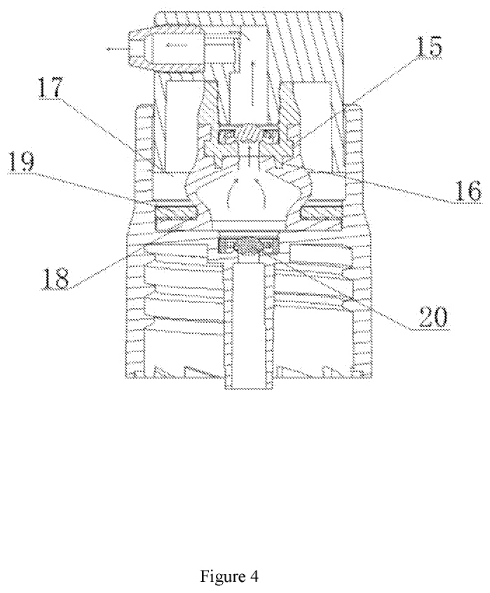

As shown in FIG. 4, when pressing the button 2, the pressure in the flexible cushioning cavity 10 is increased, at this time, the pressure in the flexible cushioning cavity 10 presses the lower valve disc 20 of the lower one-way valve 6, the lower one-way valve 6 is closed, the upper one-way valve 3 is opened, the liquid is dispensed out through the nozzle 8 along the liquid passage 9 from the flexible cushioning cavity 10.

Apparently, the embodiments of the present invention are only examples for explaining the present invention, rather than limitation on the embodiments of the present invention. For those of ordinary skill in the art, other changes or modifications in various forms can be made to the foregoing description. The embodiments of the present invention are not necessarily exhaustively given here, which is not possible either. And all obvious changes or modifications to the substantive spirit of the present invention fall into the protection scope of the present invention.

1. A full-plastic vacuum pump head, comprising a cap, a button, an upper one-way valve, a flexible rubber pump body, a lower one-way valve and a lid, wherein the button is movable sleeved in the lid, the button engages with the lid by sliding, a nozzle communicating with the upper one-way valve is provided on the button, the nozzle, the upper one-way valve, the flexible rubber pump body and the lower one-way valve are communicated in sequence through a liquid passage, the flexible rubber pump body is made of a flexible rubber material, a flexible cushioning cavity is provided in the flexible rubber pump body, and when the lid is pressed on, a liquid in the flexible cushioning cavity is guided out through the upper one-way valve, and when the lid is released, the liquid is guided into the flexible cushioning cavity through the lower one-way valve.

2. The full-plastic vacuum pump head according to claim 1, wherein the flexible cushioning cavity comprises an upper cylindrical cavity and a lower bowl-shaped cavity, the cylindrical cavity is communicated with the upper one-way valve, a diameter of the cylindrical cavity is smaller than or equals a diameter of an upper opening of the bowl-shaped cavity, the diameter of the upper opening of the bowl-shaped cavity is smaller than a diameter of an intermediate portion of the bowl-shaped cavity and an inner cavity wall of the bowl-shaped cavity is curved inwardly.

3. The full-plastic vacuum pump head according to claim 2, wherein a frustum cavity communicating with the cylindrical cavity is provided at an upper portion of the bowl-shaped cavity, diameters of the frustum cavity are increased going down, a ring-shaped groove with an inwardly curved surface is provided at a lower portion of the flexible rubber pump body relative to the cylindrical cavity, wherein the frustum cavity is a frustum structure which is smaller at an upper portion while bigger at a lower portion.

4. The full-plastic vacuum pump head according to claim 1, wherein the button comprises an outer sleeve being engaged with the lid via sliding and an inner tube communicating with the nozzle, wherein the upper one-way valve comprises a valve seat and an upper valve disc, an upper sleeve portion airlessly joined over the inner tube is provided at an upper end of the valve seat, a lower end portion of the valve seat is airlessly fitted at an upper end portion of the flexible rubber pump body and the upper valve disc is provided inside the valve seat.

5. The full-plastic vacuum pump head according to claim 4, wherein a fitting sleeve airlessly and tightly connected to a lower portion of the valve seat provided at an upper end portion of the flexible rubber pump body, a ring-shaped outer slot extending radially and a ring-shaped lower slot extending axially are provided at a bottom portion of the fitting sleeve; a ring-shaped outer edge extending radially is provided at a lower portion of the valve seat, the ring-shaped outer edge engages airlessly with the ring-shaped outer slot, and a ring-shaped lower edge extending axially is provided at a lower end of the valve seat, the ring-shaped lower edge engages airlessly with the ring-shaped lower slot, and the liquid passage of the valve seat and the flexible rubber pump body is located inside a circular area enclosed by the ring-shaped lower edge.

6. The full-plastic vacuum pump head according to claim 1, wherein a closure that is coupled over the flexible rubber pump body is provided at an upper portion of the lid, a ring-shaped movement cavity engaging with the button adaptively by sliding is provided in between the closure and the flexible rubber pump body, a ring-shaped neck extending radially outwards is provided at the lower end portion of the flexible rubber pump body, the ring-shaped neck is airlessly provided at a bottom portion of the ring-shaped movement cavity, a ring-shaped slab is provided on an upper end portion of the ring-shaped neck, the ring-shaped slab is installed at a lower portion of the ring-shaped movement cavity, and the ring-shaped slab is configured to fix the ring-shaped neck at the bottom portion of the ring-shaped movement cavity.

7. The full-plastic vacuum pump head according to claim 1, wherein a housing cavity for installing the lower one-way valve is provided at an intermediate portion of the lid, a liquid inlet is provided at a lower end of the housing cavity, the lower one-way valve comprises a lower valve disc connected with the housing cavity movably, and a diameter of the lower valve disc is bigger than a diameter of the liquid inlet.

8. A vessel equipped with full-plastic vacuum pump head, comprises a cap, the full-plastic vacuum pump head and a vessel body, wherein the cap is closed over the full-plastic vacuum pump head as recited according to claim 1, and the lower one-way valve of the full-plastic vacuum pump head is communicated with a liquid storage cavity provided in the vessel body and a piston is provided in the liquid storage cavity.
